(19) United States
(12) Patent Application Publication
(10) Pub. No.: US 2022/0341844 A1
(43) Pub. Date: Oct. 27, 2022

(54) CALIBRATION APPARATUS AND CALIBRATION METHOD

(71) Applicant: Tokyo Electron Limited, Tokyo (JP)

(72) Inventors: Yuto USUKI, Miyagi (JP); Kippei SUGITA, Miyagi (JP); Mitsuru DOHIWA, Miyagi (JP); Takashi NIINUMA, Miyagi (JP); Hisanori SAKAI, Miyagi (JP)

(73) Assignee: Tokyo Electron Limited, Tokyo (JP)

(21) Appl. No.: 17/729,000

(22) Filed: Apr. 26, 2022

(30) Foreign Application Priority Data
Apr. 26, 2021 (JP) 2021-073983

(51) Int. Cl. G01N 21/27; G01N 21/25

(52) U.S. Cl. CPC G01N 21/274; G01N 21/255; G01N 2201/1273; G01N 2201/062

(57) ABSTRACT

A calibration apparatus for calibrating an emission spectroscopy analyzer that monitors plasma generated in a plasma processing apparatus. The calibration apparatus comprises a base substrate; a plurality of light emitting devices disposed on the base substrate, each light emitting device of the plurality of light emitting devices is configured to emit light having different wavelengths from other light emitting devices of the plurality of light emitting devices; a reflector disposed on the base substrate, the reflector configured to reflect the light emitted by the plurality of light emitting devices toward an outside of the base substrate in a plan view; and a control device disposed on the base substrate, the control device configured to control the plurality of light emitting devices.

### CROSS-REFERENCE TO RELATED APPLICATION

This application claims priority to Japanese Patent Application No. 2021-073983, filed on Apr. 26, 2021, the entire contents of which is incorporated herein by reference.

### TECHNICAL FIELD

Exemplary embodiments of the present disclosure relate to a calibration apparatus and a calibration method.

### BACKGROUND

Patent Document 1 discloses a plasma processing apparatus. In the plasma processing apparatus, a change in a wavelength spectrum of plasma light generated in the plasma processing apparatus is monitored by an emission spectroscopy analyzer.

### PRIOR ART DOCUMENTS

### Patent Documents

Patent Document 1:

Japanese Patent Application Publication No. 2020-65013

### SUMMARY

### Technical Problem

The present disclosure provides techniques for calibrating an emission spectroscopy analyzer that monitors plasma generated in a plasma processing apparatus.

### Solutions to Problems

In accordance with an exemplary implementation of the present disclosure, there is provided a calibration apparatus for calibrating an emission spectroscopy analyzer that monitors plasma generated in a plasma processing apparatus. The calibration apparatus comprises a base substrate; a plurality of light emitting devices disposed on the base substrate, each light emitting device of the plurality of light emitting devices is configured to emit light having different wavelengths from other light emitting devices of the plurality of light emitting devices; a reflector disposed on the base substrate, the reflector configured to reflect the light emitted by the plurality of light emitting devices toward an outside of the base substrate in a plan view; and a control device disposed on the base substrate, the control device configured to control the plurality of light emitting devices.

### Advantageous Effects

According to a calibration apparatus according to one exemplary embodiment, the emission spectroscopy analyzer that monitors the plasma generated in the plasma processing apparatus can be calibrated.

### BRIEF DESCRIPTION OF DRAWINGS

FIG. 1 is a diagram illustrating a processing system.

FIG. 2 is a perspective view illustrating an aligner.

FIG. 3 is a view illustrating an example of a plasma processing apparatus.

FIG. 4 is a plan view of an exemplary calibration apparatus viewed from an upper surface side.

FIG. 5 is a cross-sectional view taken along a line V-V of FIG. 4.

FIG. 6 is a block diagram illustrating the exemplary calibration apparatus.

FIG. 7 is a schematic diagram for describing an acceleration sensor of the exemplary calibration apparatus.

FIG. 8 is an example of a graph for describing acceleration applied to the exemplary calibration apparatus.

FIG. 9 is a view illustrating an example of a transport path of the calibration apparatus transported into the processing system.

FIG. 10 is an example of a transport recipe used by the exemplary calibration apparatus.

FIG. 11 is a flowchart illustrating an example of an operation method of the calibration apparatus.

FIG. 12 is a view for describing a light emitting device according to another example.

### DETAILED DESCRIPTION

Hereinafter, various exemplary embodiments will be described.

In one exemplary embodiment, a calibration apparatus for calibrating an emission spectroscopy analyzer that monitors plasma generated in a plasma processing apparatus is provided. The calibration apparatus is provided with a plate-shaped base substrate, a plurality of light sources, a reflection member, and a control device. The plurality of light sources are disposed on the base substrate, and emit light having different wavelengths from each other. The reflection member is disposed on the base substrate, and reflects the light emitted from the plurality of light sources toward an outside of the base substrate in a plan view. The control device is disposed on the base substrate and controls the plurality of light sources.

In the calibration apparatus of the embodiment, the control device controls the plurality of light sources to emit light from the plurality of light sources in a state where the calibration apparatus is disposed on a stage provided in the plasma processing apparatus. Light emitted from the plurality of light sources is reflected toward an outside of the base substrate in a plan view by the reflection member. In the plasma processing apparatus, in a case where a window through which light is incident on the emission spectroscopy analyzer is provided on a side of the stage, the light from the light source reflected by the reflection member is likely to be incident on the emission spectroscopy analyzer. That is, the intensity of light incident on the emission spectroscopy analyzer increases. Since the light from the plurality of light sources can be used as a reference for calibration, the emission spectroscopy analyzer that monitors the plasma generated in the plasma. processing apparatus can be calibrated.

In one exemplary embodiment, each of the plurality of light sources is an LED light source.

In one exemplary embodiment, the base substrate has a disk shape and includes a notch at a part of a peripheral edge. In a case where the processing system includes an aligner that controls a rotational position of a wafer, the aligner can control the rotational position of the calibration apparatus.

In one exemplary embodiment, the plurality of light sources are arranged in a circumferential direction along the peripheral edge of the base substrate. With this configuration, in the plasma processing apparatus, in a case where the window through which light is incident on the emission spectroscopy analyzer is provided on the side of the stage, any of the plurality of light sources can be brought close to the window.

In one exemplary embodiment, an acceleration sensor disposed on the base substrate may be further provided. The control device may recognize a transport position of the calibration apparatus in the plasma processing apparatus based on an output value of the acceleration sensor, and may cause the plurality of light sources to emit light when it is recognized that the calibration apparatus is transported to a predetermined position. With this configuration, the plurality of light sources can be caused to emit light at the timing when the calibration apparatus is transported onto the stage by the transport device.

In one exemplary embodiment, a calibration apparatus for calibrating an emission spectroscopy analyzer that monitors plasma generated in a plasma processing apparatus is provided. The calibration apparatus is provided with a plate-shaped base substrate, a plurality of light sources, and a control device. The plurality of light sources are disposed on the base substrate, and emit light having different wavelengths from each other. The control device controls the plurality of light sources. An optical axis of the light source is directed toward the outside of the base substrate in a plan view.

In the calibration apparatus of the embodiment, the control device controls the plurality of light sources to emit light from the plurality of light sources in a state where the calibration apparatus is disposed on a stage provided in the plasma processing apparatus. Light emitted from the plurality of light sources is irradiated toward the outside of the base substrate in a plan view. In the plasma processing apparatus, in a case where the window through which light is incident on the emission spectroscopy analyzer is provided on the side of the stage, the light from the light source is likely to be incident on the emission spectroscopy analyzer. That is, the intensity of light incident on the emission spectroscopy analyzer increases. Since the light from the plurality of light sources can be used as a reference for calibration, the emission spectroscopy analyzer that monitors the plasma generated in the plasma processing apparatus can be calibrated.

In one exemplary embodiment, a method of calibrating the emission spectroscopy analyzer that monitors the plasma generated in the plasma processing apparatus using the calibration apparatus is provided. The calibration apparatus may be any one of the above-described calibration apparatuses. The method includes a step of transporting the calibration apparatus into the plasma processing apparatus by the transport device. In addition, the method includes a step of causing the plurality of light sources of the calibration apparatus transported into the plasma processing apparatus to emit light, and the method includes a step of measuring intensity data of light emitted from the plurality of light sources by the emission spectroscopy analyzer. In addition, the method also includes a step of calibrating the emission spectroscopy analyzer based on the intensity data.

Hereinafter, various exemplary embodiments will be described in detail with reference to the drawings. Further, like reference numerals will be given to like or corresponding parts throughout the drawings.

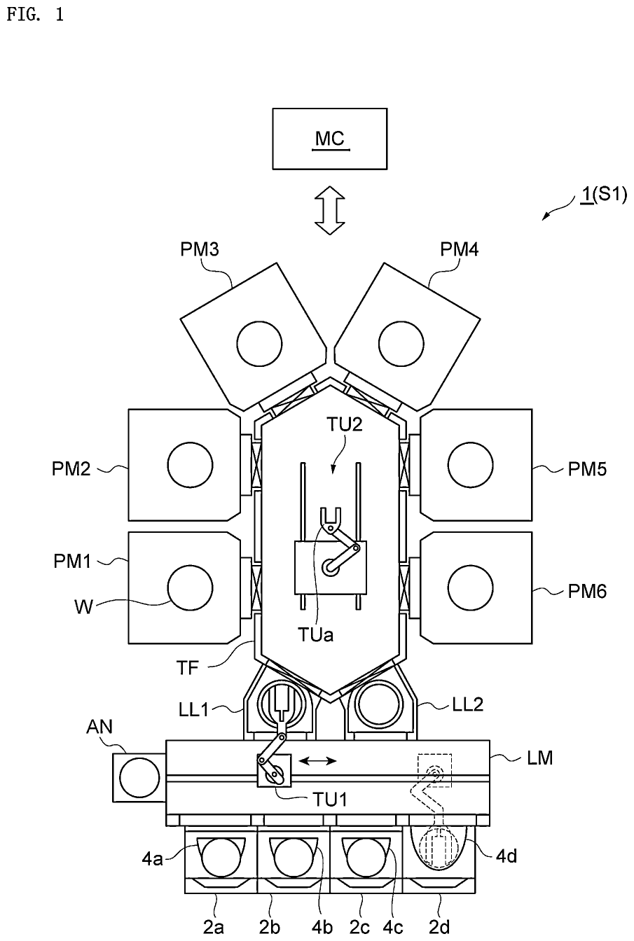

The calibration apparatus according to one exemplary embodiment may be transported by the processing system 1 that functions as a semiconductor manufacturing apparatus S1. First, a processing system that includes a processing apparatus for processing a workpiece and a transport device for transporting the workpiece to the processing apparatus will be described. FIG. 1 is a diagram illustrating the processing system. The processing system 1 is provided with stages 2a to 2d, containers 4a to 4d, a loader module LM, an aligner AN, load-lock modules LL1 and LL2, process modules PM1 to PM6, a transfer module TF, and a controller MC. The number of stages 2a to 2d, the number of containers 4a to 4d, the number of load-lock modules LL1 and LL2, and the number of process modules PM1 to PM6 are not limited, and may be any number of one or more.

The stages 2a to 2d are arranged along one side of a loader module LM. The containers 4a to 4d are placed on the stages 2a to 2d, respectively. Each of the containers 4a to 4d is, e.g., a container referred to as a Front Opening Unified Pod (FOUP). Each of the containers 4a to 4d may be configured to accommodate a workpiece W. The workpiece W has an approximate disc shape like a wafer.

The loader module LM has a chamber wall defining in an inside thereof a transport space in an atmospheric pressure stale. A transport device TU1 is provided in the transport space. The transport device TU1 is, for example, an articulated robot and is controlled by the controller MC. The transport device TU1 is configured to transport the workpiece W between the containers 4a to 4d and the aligner AN, between the aligner AN and the load-lock modules LL1 to LL2, and between the load-lock modules LL1 to LL2 and the containers 4a to 4d.

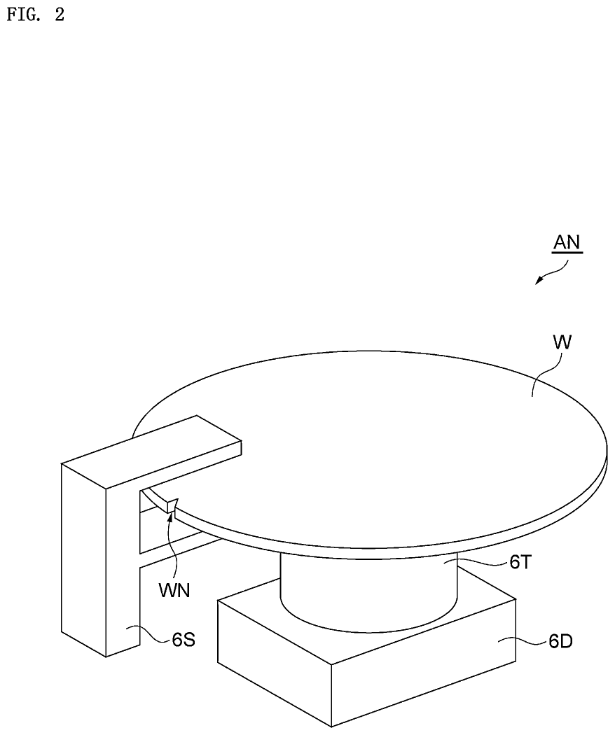

The aligner AN is connected to the loader module LM. The aligner AN is configured to adjust a position (calibration of position) of the workpiece W. FIG. 2 is a perspective view illustrating the aligner. The aligner AN includes a support stand 6T, a driving device 6D, and a sensor 6S. The support stand 6T is a stand that can rotate around an axis extending in a vertical direction, and is configured to support the workpiece W thereon. The support stand 6T is rotated by the driving device 6D. The driving device 6D is controlled by the controller MC. When the support stand 6T is rotated by the power from the driving device 6D, the workpiece W placed on the support stand 6T is also rotated.

The sensor 6S is an optical sensor and detects an edge of the workpiece W while the workpiece W is rotated. The sensor 6S detects a misalignment amount of the angular position of a notch WN (or another marker) of the workpiece W with respect to a reference angular position, and a misalignment amount of the central position of the workpiece W with respect to the reference position from the detection result of the edge. The sensor 6S outputs the misalignment amount of the angular position of the notch WN and the misalignment amount of the central position of the workpiece W to the controller MC. The controller MC calculates a rotation amount of the support stand 6T for correcting the angular position of the notch WN to the reference angular position based on the misalignment amount of the angular position of the notch WN. The controller MC controls the driving device 6D to rotate the support stand 6T only by the rotation amount. As a result, the angular position of the notch WN can be corrected to the reference angular position. In addition, the controller MC may correct the angular position of the notch WN to an arbitrary angular position. In addition, the controller MC controls the position of an end effector of the transport device TU1 when receiving the workpiece W from the aligner AN based on the misalignment amount of the central position of the workpiece W. As a result, the central position of the workpiece W coincides with the predetermined position on the end effector of the transport device TU1.

Referring back to FIG. 1, each of the load-lock module LL1 and the load-lock module LL2 is provided between the loader module LM and the transfer module TF. Each of the load-lock modules LL1 and LL2 provides a preliminary depressurization chamber.

The transfer module TF is connected to the load-lock module LL1 and the load-lock module LL2 in an airtight manner through a gate valve. The transfer module TF provides a decompression chamber capable of depressurization. The decompression chamber is provided with a transport device TU2. The transport device TU2 is, for example, an articulated robot having a transport arm TUa and is controlled by the controller MC. The transport device TU2 is configured to transport the workpiece W between the load-lock modules LL1 to LL2 and the process modules PM1 to PM6, and between any two of the process modules PM1 to PM6.

The process modules PM1 to PM6 are connected to the transfer module TF in an airtight manner through gate valves. Each of the process modules PM1 to PM6 is a processing apparatus configured to perform dedicated processing such as plasma processing on the workpiece W.

A series of operations when the processing of the workpiece W is performed in the processing system 1 will be exemplified as follows. The transport device TU1 of the loader module LM takes out the workpiece W from any one of the containers 4a to 4d, and transports the workpiece W to the aligner AN. Next, the transport device TU1 takes out the workpiece W whose position is adjusted from the aligner AN, and transports the workpiece W to one load-lock module of the load-lock module LL1 and the load-lock module LL2. Next, one load-lock module decompresses the pressure in the preliminary decompression chamber to a predetermined pressure. Next, the transport device TU2 of the transfer module TF takes out the workpiece W from one load-lock module, and transports the workpiece W to any one of the process modules PM1 to PM6. One or more process modules of the process modules PM1 to PM6 process the workpiece W. The transport device TU2 transports the processed workpiece W from the process module to one load-lock module of the load-lock module LL1 and the load-lock module LL2. Next, the transport device TU1 transports the workpiece W from one load-lock module into any one of the containers 4a to 4d.

The processing system 1 is provided with the controller MC as described above. The controller MC may be a computer including a processor, a storage device such as a memory, a display device, an input and output device, a communication device, and the like. A series of operations of the processing system 1 described above is realized by the control of each part of the processing system 1 by the controller MC according to a program stored in the storage device.

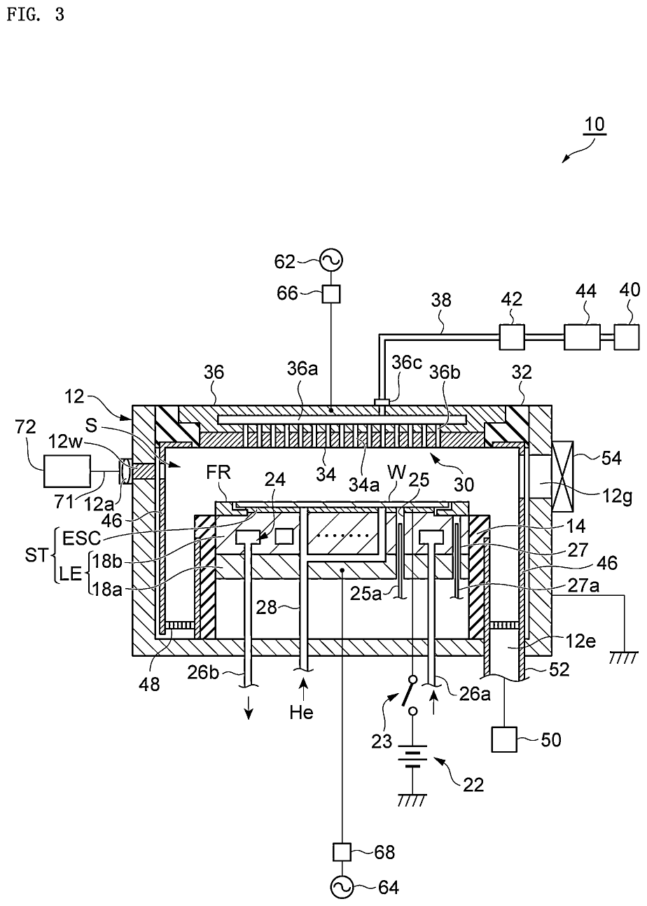

FIG. 3 is a view illustrating an example of the plasma processing apparatus which may be adopted as any one of the process modules PM1 to PM6. A plasma processing apparatus 10 illustrated in FIG. 3 is a capacitively-coupled plasma etching apparatus. The plasma processing apparatus 10 is provided with a substantially cylindrical chamber main body 12. The chamber main body 12 is made of, for example, aluminum, and the inner wall surface thereof may be subjected to anodization. The chamber main body 12 is grounded for safety.

A substantially cylindrical support 14 is provided on a bottom portion of the chamber main body 12. The support 14 is made of, for example, an insulating material. The support 14 is provided in the chamber main body 12 and extends upward from the bottom of the chamber main body 12. In addition, a stage ST is provided in the chamber S provided by the chamber main body 12. The stage ST is supported by the support 14.

The stage ST has a lower electrode LE and an electrostatic chuck ESC. The lower electrode LE includes a first plate 18a and a second plate 18b. The first plate 18a and the second plate 18b are substantially disk-shaped and are made of, for example, metal such as aluminum. The second plate 18b is provided on the first plate 18a and is electrically connected to the first plate 18a.

The electrostatic chuck ESC is provided on the second plate 18b. The electrostatic chuck ESC has a structure in which an electrode as a conductive film is disposed between a pair of insulating layers or insulating sheets, and has an approximate disc shape. A DC power source 22 is electrically connected to the electrode of the electrostatic chuck ESC through a switch 23. The electrostatic chuck ESC adsorbs the workpiece W by an electrostatic force such as a Coulomb force generated by a DC voltage from the DC power source 22. As a result, the electrostatic chuck ESC can hold the workpiece W.

A focus ring FR is provided on a peripheral portion of the second plate 18b. The focus ring FR is provided to surround the edge of the workpiece W and the electrostatic chuck ESC. The focus ring FR may be formed of any one of various materials such as silicon, silicon carbide, and silicon oxide.

A coolant passage 24 is provided in the second plate 18b. The coolant passage 24 includes a temperature control device. A coolant is supplied from a chiller unit provided outside the chamber main body 12 to the coolant passage 24 through a pipe 26a. The coolant supplied to the coolant passage 24 is returned to the chiller unit through the pipe 26b. In this manner, the coolant is circulated between the coolant passage 24 and the chiller unit. By controlling the temperature of the coolant, the temperature of the workpiece W supported by the electrostatic chuck ESC is controlled.

A plurality (for example, three) of through-holes 25 penetrating the stage ST are formed in the stage ST. The through-holes 25 are formed inside the electrostatic chuck ESC in a plan view. A lift pin 25a is inserted into each of the through-holes 25. FIG. 3 illustrates one through-hole 25 into which one lift pin 25a is inserted. The lift pin 25a is vertically movable in the through-holes 25. As the lift pin 25a rises, the workpiece W supported on the electrostatic chuck ESC rises.

In the stage ST, a plurality (for example, three) of through-holes 27 penetrating the stage ST (lower electrode LE) are formed at positions outside the electrostatic chuck ESC in a plan view. The lift pin 27a is inserted into each of the through-holes 27. FIG. 3 illustrates one through-hole 27 into which one lift pin 27a is inserted. The lift pin 27a is vertically movable in the through-holes 27. As the lift pin 27a rises, the focus ring FR supported on the second plate 18b rises.

In addition, the plasma processing apparatus 10 is provided with a gas supply line 28. The gas supply line 28 supplies a heat transfer gas from a heat transfer gas supply mechanism, for example, a He gas, to a space between the upper surface of the electrostatic chuck ESC and the rear surface of the workpiece W.

In addition, the plasma processing apparatus 10 is provided with an upper electrode 30. The upper electrode 30 is disposed above the stage ST so as to face the stage ST. The upper electrode 30 is supported on an upper portion of the chamber main body 12 via an insulating shielding member 32. The upper electrode 30 may include a top plate 34 and a support body 36. The top plate 34 faces the chamber S, and a plurality of gas discharge holes 34a are provided in the top plate 34. The top plate 34 may be formed of silicon or quartz. Alternatively, the top plate 34 may be configured by forming a plasma-resistant film such as yttrium oxide on the surface of an aluminum base material.

The support 36 supports the top plate 34 in a detachable manner, and may be made of, for example, a conductive material such as aluminum. The support 36 may have a water-cooled structure. A gas diffusion chamber 36a is provided in the interior of the support 36. A plurality of gas flow holes 36b communicating with the gas discharge holes 34a extend downward from the gas diffusion chamber 36a. in addition, a gas introduction port 36c for guiding the processing gas into the gas diffusion chamber 36a is formed in the support 36, and a gas supply pipe 38 is connected to the gas introduction port 36c.

A gas source group 40 is connected to the gas supply pipe 38 through a valve group 42 and a flow rate controller group 44. The gas source group 40 includes a plurality of gas sources for a plurality of types of gases. The valve group 42 includes a plurality of valves, and the flow rate controller group 44 includes a plurality of flow rate controllers such as mass flow controllers. The plurality of gas sources of the gas source group 40 are connected to the gas supply pipe 38 through the corresponding valves of the valve group 42 and the corresponding flow rate controllers of the flow rate controller group 44, respectively.

In addition, in the plasma processing apparatus 10, a deposition shield 46 is detachably provided along the inner wall of the chamber main body 12. The deposition shield 46 is also provided on the outer periphery of the support 14. The deposition shield 46 prevents an etching by-product (deposition) from adhering to the chamber main body 12, and may be configured by coating a ceramic such as yttrium oxide on an aluminum material.

An exhaust plate 48 is provided on the bottom portion side of the chamber main body 12 and between the support 14 and the side wall of the chamber main body 12. The exhaust plate 48 may be configured, for example, by coating an aluminum material with ceramic such as yttrium oxide. The exhaust plate 48 is formed with a plurality of holes penetrating in the plate thickness direction. An exhaust port 12e is provided below the exhaust plate 48 and in the chamber main body 12. An exhaust device 50 is connected to the exhaust port 12e via an exhaust pipe 52. The exhaust device 50 includes a pressure adjusting valve and a vacuum pump such as a turbo molecular pump, and can decompress the space in the chamber main body 12 to a desired degree of vacuum. In addition, a loading and unloading port 12g for the workpiece W is provided in the side wall of the chamber main body 12, and the loading and unloading port 12g can be opened and closed by the gate valve 54.

In addition, the plasma processing apparatus 10 is further provided with a first radio-frequency power supply 62 and a second radio-frequency power supply 64. The first radio-frequency power supply 62 is a power source that generates a first radio-frequency for generating plasma, and generates a radio-frequency having a frequency of, for example, 27 to 100 MHz. The first radio-frequency power supply 62 is connected to the upper electrode 30 via a matcher 66. The matcher 66 includes a circuit for matching the output impedance of the first radio-frequency power supply 62 with the input impedance on a load side (upper electrode 30 side). The first radio-frequency power supply 62 may be connected to the lower electrode LE via the matcher 66.

The second radio-frequency power supply 64 is a power source that generates a second radio-frequency for drawing ions into the workpiece W, and generates a radio-frequency having a frequency in the range of, for example, 400 kHz to 13.56 MHz. The second radio-frequency power supply 64 is connected to the lower electrode LE through the matcher 68. The matcher 68 includes a circuit for matching the output impedance of the second radio-frequency power supply 64 with the input impedance of the load side (lower electrode LE side).

In the plasma processing apparatus 10, gases from one or more gas sources selected from the plurality of gas sources are supplied into the chamber S. In addition, the pressure in the chamber S is set to a predetermined pressure by the exhaust device 50. Furthermore, the gas in the chamber S is excited by the first radio-frequency from the first radio-frequency power supply 62. As a result, plasma is generated. The workpiece W is processed by the generated active species. If necessary, the ions may be attracted into the workpiece W by the bias based on the second radio-frequency of the second radio-frequency power supply 64.

The chamber main body 12 has a window 12w through which light is to be transmitted. The window 12w may have, for example, a honeycomb double window structure. In this case, the entry of plasma and radicals into the window 12w is suppressed, and the amount of reaction products that adhere to the window 12w is reduced. A light collector 12a such as a lens or a mirror may be disposed outside the window 12w. An emission spectroscopy analyzer 72 is connected to the window 12w via the light collector 12a and an optical fiber 71. The emission spectroscopy analyzer 72 analyzes the emission intensity of the plasma generated in the chamber S. The emission spectroscopy analyzer 72 receives light from the plasma through the window 12w. In addition to an operation in a normal mode in which the emission intensity of plasma is analyzed, the emission spectroscopy analyzer 72 can be operated in a maintenance mode. In the maintenance mode, the calibration of a spectrometer installed in the emission spectroscopy analyzer 72 is performed based on a predetermined light source.

Subsequently, the calibration apparatus will be described. The calibration apparatus emits light that serves as a reference when the calibration of the emission spectroscopy analyzer 72 operating in the maintenance mode is performed. That is, the calibration apparatus 100 is a so-called reference instrument for calibration of the emission spectroscopy analyzer 72. The exemplary calibration apparatus 100 may be referred to as a jig because the calibration apparatus 100 is a device for disposing a light source at a predetermined position on the stage ST in the process module PM.

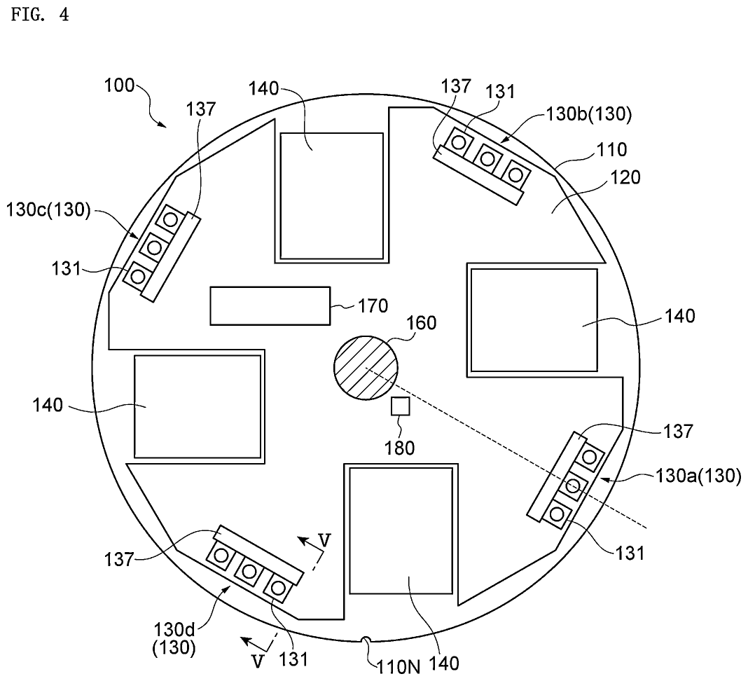

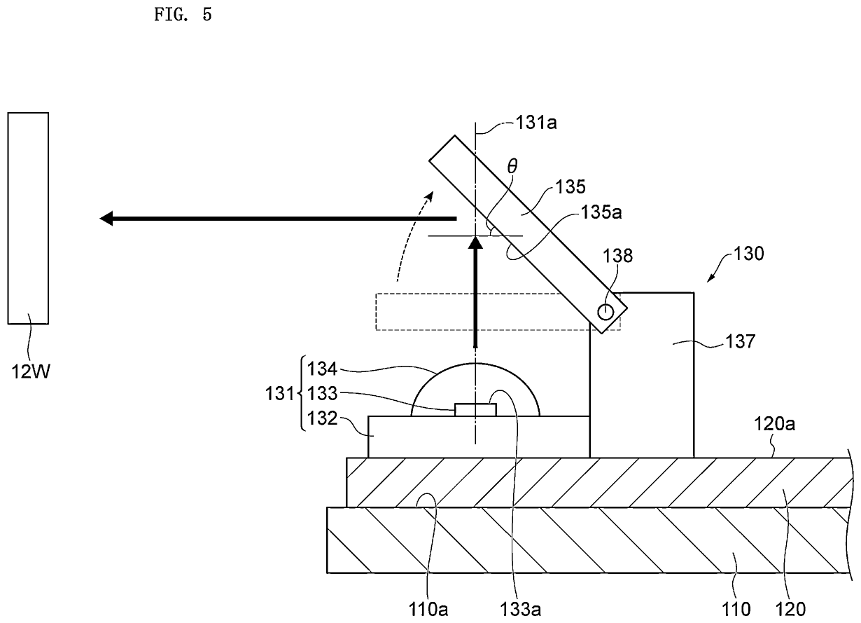

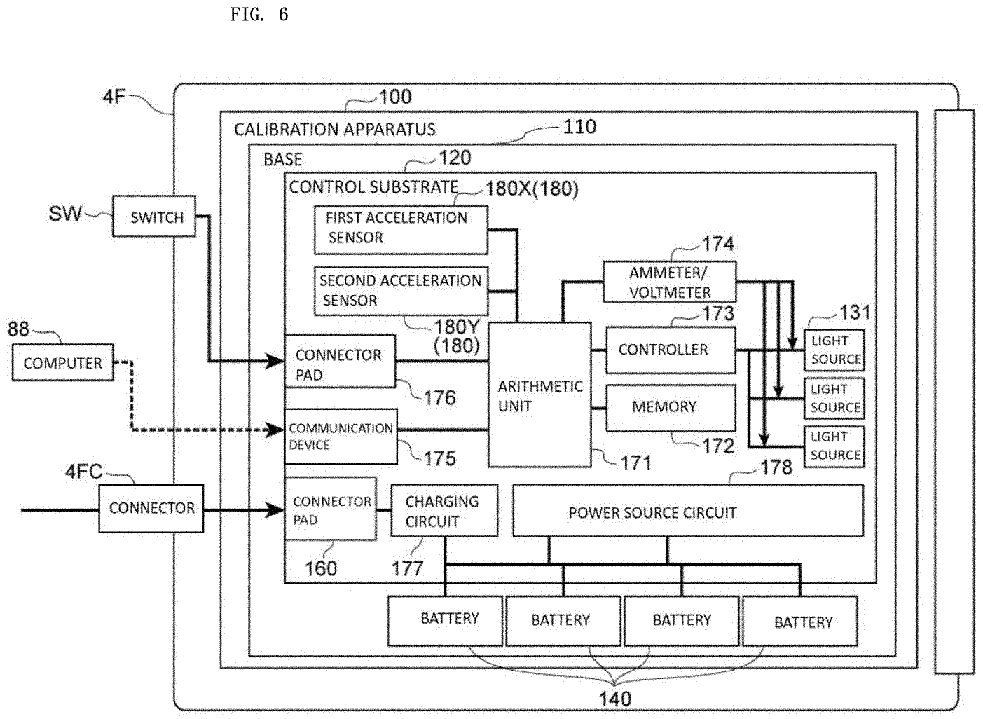

FIG. 4 is a plan view of the calibration apparatus 100 according to the embodiment viewed from the upper surface side. FIG. 5 is a view illustrating the light emitting device 130 provided in the calibration apparatus 100, and is a cross-sectional view taken along a line V-V of FIG. 4. FIG. 6 is a block diagram illustrating the calibration apparatus. FIG. 6 also schematically illustrates a dedicated FOUP 4F to be used when the calibration apparatus 100 is used. The calibration apparatus 100 includes a base substrate 110, a control substrate 120, and a battery 140. The calibration apparatus 100 is transported by the transport device of the processing system 1 that functions as the semiconductor manufacturing apparatus S1, and causes the plurality of light emitting devices 130 to emit light.

The base substrate 110 is a substrate including a disk-shaped wafer as an example. However, the base substrate 110 is not limited to the disk shape, and is not limited to the shape such as a polygon or an ellipse as long as the base substrate 110 can be transported by the transport device that transports the substrate. A notch 110N is formed at the edge of the base substrate 110. Examples of the material of the substrate include silicon, carbon fiber, quartz glass, silicon carbide, silicon nitride, and alumina.

The control substrate 120 is a circuit substrate provided on the upper surface of the base substrate 110, and includes a plurality of light emitting devices 130A to 130D (hereinafter, the light emitting devices are collectively referred to as “light emitting device 130”), a connector pad 160, a control circuit 170, and an acceleration sensor 180.

The light emitting devices 130A to 130D are disposed, for example, on the control substrate 120. As illustrated in FIG. 4, the exemplary light emitting devices 130A to 130D are disposed apart from each other at equal intervals in the circumferential direction on the peripheral edge of the control substrate 120. The light emitting device 130 includes a light source 131 and a reflection member 135. The exemplary light source 131 is a light emitting diode (LED) light source, and includes a substrate 132, an LED element 133 provided on the substrate 132, and a lens 134 that covers the LED element 133. The light source 131 may be an organic light emitting diode (OLED). The light source 131 emits light that serves as a reference for calibration in the maintenance mode of the emission spectroscopy analyzer 72. That is, the emission spectroscopy analyzer 72 operating in the maintenance mode is calibrated in a state where the light source 131 emits light in the process module PM. For example, intensity data of the light output from the light source 131 is obtained in advance by the emission spectroscopy analyzer that serves as a reference. The emission spectroscopy analyzer 72 to be calibrated connected to the plasma processing apparatus 10 may store the intensity data. of the light output from the light source 131 as reference data for calibration.

In an example, the substrate 132 has a rectangular plate shape. In addition, an orientation of an optical axis 131a of the exemplary light source 131 may be perpendicular to an upper surface 110a of the base substrate 110. The orientation of the optical axis 131a may be defined as an orientation perpendicular to a light emitting surface 133a of the LED element 133. In an example, the light emitting surface 133a of the LED element 133 is parallel to the upper surface 120a of the control substrate 120 and the upper surface 110a of the base substrate 110. Each of the light emitting devices 130A to 130D has a plurality of light sources 131. In the illustrated examples, each of the light emitting devices 130A to 130D has three light sources 131. The light source 131 of the light emitting device 130A, the light source 131 of the light emitting device 130B, the light source 131 of the light emitting device 130C, and the light source 131 of the light emitting device 130D emit light having different wavelengths from each other (that is, different colors), respectively. The number of the light sources 131 of each wavelength is not limited to three, and may be two or less or four or more.

The reflection member 135 is a reflector that reflects light output from the light source 131 toward the outside of the base substrate 110 in a plan view. The exemplary reflection member 135 may be a reflecting plate (mirror). The reflection member 135 has a planar reflecting surface 135a that reflects light. The reflecting surface may be a surface that specularly reflects the incident light. The reflection member 135 in the illustrated example is supported by a support 137. The support in the illustrated example has a rectangular parallelepiped shape.

The support 137 is located closer to the center of the control substrate 120 (base substrate 110) than the light source 131 on the control substrate 120. In the illustrated example, the three light sources 131 constituting one light emitting device 130 are arranged to be spaced apart from each other in a direction intersecting (orthogonal in the illustrated example) the radial direction of the base substrate 110. The support 137 is disposed at a position in contact with the three light sources 131 on a central side from the three light sources 131 in the radial direction of the base substrate 110. The support 137 has a height higher than the height of the light source 131.

The base end of the reflection member 135 is connected to the upper end of the support 137. The reflection member 135 projects above the light source 131 from the upper end of the support 137. The length from the base end to the distal end of the reflection member 135 may be, for example, substantially the same as the length of the substrate 132 of the light source 131 in the radial direction of the base substrate 110. In addition, the reflecting surface 135a of the reflection member 135 and the surface parallel to the upper surface of the substrate 132 intersect with each other at a predetermined angle. An angle θ formed by the reflecting surface 135a and the surface parallel to the upper surface of the substrate 132 may be determined according to the height of the window 12W to which the emission spectroscopy analyzer 72 is connected. For example, the angle θ of the reflection member 135 may be adjusted so that the optical axis 131a of the light source 131 is directed toward the window 12W when the optical axis 131a is reflected by the reflecting surface 135a in a state where the calibration apparatus 100 is placed on the electrostatic chuck ESC of the stage ST. The reflection member 135 may be fixed to the support 137 by a fastening member 138 such as a screw to prevent the angle θ from being misaligned. The angle θ of the reflection member 135 may be approximately 42° to 48° as an example, in a case where the heights of the reflection member 135 and the window 12w are substantially the same as each other, and the angle θ is not limited thereto. As illustrated by a broken line in FIG. 6, the angular position of the reflection member 135 may be adjustable.

The connector pad 160 is a connector for charging the battery, and may be connected to an external power source. The connector pad 160 is connected to the external power source through a connector 4FC provided in the dedicated FOUP 4F in a state of being placed in the dedicated FOUP 4F. Four batteries 140 are disposed on the base substrate 110. The battery 140 supplies power to the light emitting devices 130a to 130d and the control circuit 170. The number of batteries 140 is not limited to four as long as the battery 140 can withstand the maximum current values of the light emitting devices 130a to 130d. As illustrated in FIG. 6, a charging circuit 177 is connected between the connector pad 160 and the battery 140, and the charging of the battery 140 is controlled by the charging circuit 177. In addition, a power source circuit 178 is connected to the battery 140, and power from the battery 140 is supplied to each device through the power source circuit 178.

The control circuit 170 is disposed on the control substrate 120, includes an arithmetic unit 171 including a processor, a memory 172, a controller 173, an ammeter/voltmeter 174, and the like, and collectively controls the operation of the calibration apparatus 100 based on a program stored in the memory 172. The control circuit 170 functions as a controller that controls each part of the calibration apparatus 100. For example, on and off of each light emitting device 130 is controlled by the controller 173 in a state where the power input to the light emitting device 130 is measured by the ammeter/voltmeter 174. In addition, in order to control communication with another external apparatus, a communication device 175 is connected to the control circuit 170. In an example, the calibration apparatus 100 may receive information, including a transport recipe described later, from an external computer 88 or the like via the communication device 175. A connection method between the communication device 175 and the computer 88 may be either wired or wireless. In an example, the calibration apparatus 100 includes a connector pad 176 connected to the control circuit 170. The connector pad 176 is connected to a switch SW provided in the dedicated FOUP 4F. The control circuit 170 may start controlling the calibration apparatus 100 based on a signal input from the switch SW.

The acceleration sensor 180 detects the transport operation of the calibration apparatus 100 in the processing system 1 by detecting the acceleration applied to the calibration apparatus 100. As illustrated in FIG. 6, the acceleration sensor 180 is configured to include at least a first acceleration sensor 180X and a second acceleration sensor 180Y.

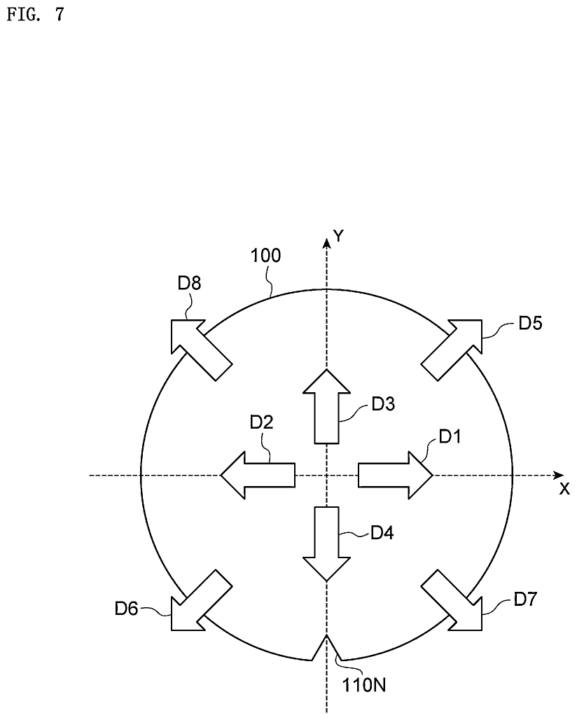

FIG. 7 is a schematic diagram for describing the acceleration sensor 180 of the calibration apparatus 100. FIG. 7 is a schematic plan view of the calibration apparatus 100 viewed from the upper side. The Y-axis in FIG. 7 passes through the center of the calibration apparatus 100 and the notch 110N. The X-axis is orthogonal to the Y-axis and passes through the center of the calibration apparatus 100. The X-axis and the Y-axis may be axes orthogonal (intersecting) to each other along a plane along the control substrate 120.

The first acceleration sensor 180X is configured to detect acceleration in the X-axis direction, and the second acceleration sensor 180Y is configured to detect acceleration in the Y-axis direction. Therefore, in a state where the calibration apparatus 100 is horizontal, the first acceleration sensor 180X can detect the acceleration in the first direction along the horizontal direction. In addition, the second acceleration sensor 180Y can detect acceleration in the second direction intersecting the first direction along the horizontal direction.

In an example, the first acceleration sensor 180X outputs a positive detection value according to the magnitude of acceleration when acceleration applied in the positive direction of the X-axis is detected, and outputs a negative detection value according to the magnitude of acceleration when acceleration applied in the negative direction of the X-axis is detected. In addition, the second acceleration sensor 180Y outputs a positive detection value according to the magnitude of acceleration when acceleration applied in the positive direction of the Y-axis is detected, and outputs a negative detection value according to the magnitude of acceleration when acceleration is applied in the negative direction of the Y-axis is detected.

In general, the square sum root is used to calculate the acceleration having vectors in the X-axis direction and the Y-axis direction. However, in the exemplary embodiment, since the positive and negative directions in the X-axis direction and the Y-axis direction are also important, an arithmetic operation using the total value is performed as follows.

In the exemplary calibration apparatus 100, each of the detection values from the first acceleration sensor 180X and the second acceleration sensor 180Y is input into the arithmetic unit 171. The arithmetic unit 171 sums the detection value of the first acceleration sensor 180X and the detection value of the second acceleration sensor 180Y to derive a total value. The arithmetic unit 171 counts the transport operations in the processing system 1 based on the total value.

In a case where the calibration apparatus 100 is transported in the directions D1 and D2 along the X-axis illustrated in FIG. 7, no acceleration is substantially detected by the second acceleration sensor 180Y. Therefore, the arithmetic unit 171 may use the detection value of only the first acceleration sensor 180X as the total value. Similarly, in a case where the calibration apparatus 100 is transported in the directions D3 and D4 along the Y-axis illustrated in FIG. 7, the arithmetic unit 171 may use the detection value of only the second acceleration sensor 180Y as the total value. In addition, in a case where the calibration apparatus is transported in the direction D5 where both the X-axis and the Y-axis are in the positive direction, and in the direction D6 where both the X-axis and the Y-axis are in the negative direction, a value obtained by adding the detection values together as they are may be used as the total value.

In a case where the calibration apparatus 100 is transported in the direction D7 where the X-axis is the positive direction and the Y-axis is the negative direction, and in the direction D8 where the X-axis is the negative direction and the Y-axis is the positive direction, the signs are opposite between the detection values of the first acceleration sensor 180X and the detection values of the second acceleration sensor 180Y. Therefore, a value obtained by subtracting the detection value of the second acceleration sensor 180Y from the detection value of the first acceleration sensor 180X may be used as the total value. Since the detection value of the first acceleration sensor 180X and the detection value of the second acceleration sensor 180Y are enough not to be canceled by the sum, a value obtained by subtracting the detection value of the first acceleration sensor 180X from the detection value of the second acceleration sensor 180Y may be used as the total value.

As an example, in a case where one of the two detection values input to the arithmetic unit 171 is substantially zero, the arithmetic unit 171 may determine that the calibration apparatus 100 is being transported in the directions D1, D2, D3, and D4, and calculate the total value. In addition, in a case where the signs of the two detection values input to the arithmetic unit 171 are the same as each other, the arithmetic unit 171 may determine that the calibration apparatus 100 is being transported in the directions D5 and D6, and calculate the total value. In addition, in a case where the signs of the two detection values input to the arithmetic unit 171 are different from each other, the arithmetic unit 171 may determine that the calibration apparatus 100 is being transported in the directions D7 and D8, and calculate the total value.

In the processing system 1, the calibration apparatus 100 is transported by the transport devices TU1 and TU2. For example, in a case where the calibration apparatus 100 that is stationary is transported to a certain position by the transport device and is stationary, the calibration apparatus 100 is accelerated in the direction opposite to the transport direction when the transport is started, and is accelerated in the transport direction when the transport is stopped. Therefore, the exemplary calibration apparatus 100 determines that a single transport operation is performed in a case where the total value of the detection value by the first acceleration sensor 180X and the detection value by the second acceleration sensor 180Y exceeds a positive first threshold value and then falls below a negative second threshold value within a predetermined time, Furthermore, the calibration apparatus 100 determines that one transport operation is performed in a case where the first negative threshold value is fallen below and then the second positive threshold value is exceeded within a predetermined time.

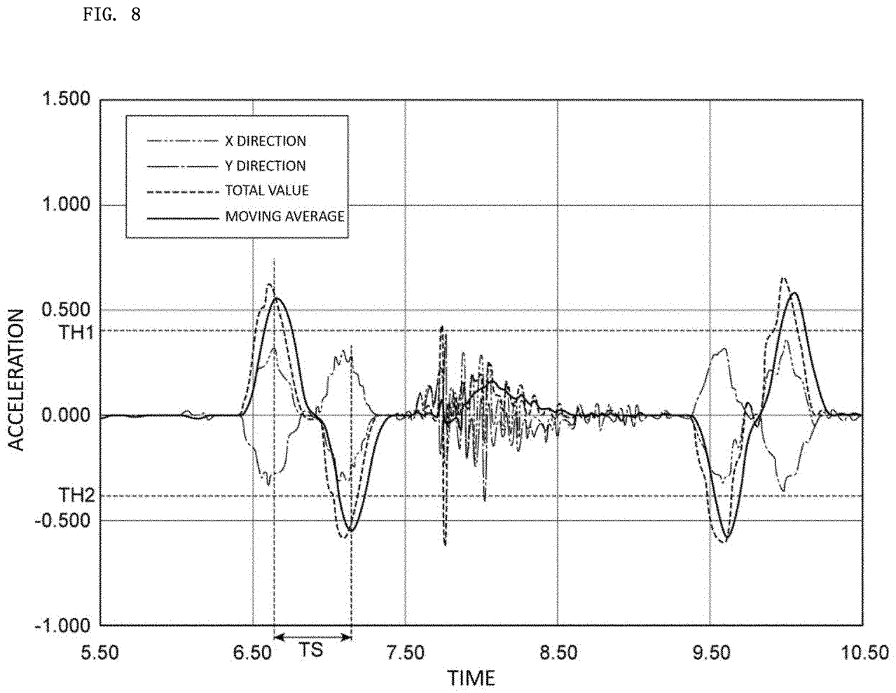

FIG. 8 is an example of a graph for describing the acceleration applied to the calibration apparatus. In FIG. 8. the detection value by the first acceleration sensor 180X is represented as “X direction”, and the detection value by the second acceleration sensor 180y is represented as “Y direction”. The total value of the detection value by the first acceleration sensor 180X and the detection value by the second acceleration sensor 180Y is represented as “total value”. In FIG. 8, since the signs of the detection values in the X direction and the Y direction are different from each other, a value obtained by subtracting the detection value in the Y direction from the detection value in the X direction is a total value. The “moving average” in the graph represents the moving average of the total values. FIG. 8 illustrates the acceleration when the two transport operations are performed at intervals of time. In this example, the detection value is disturbed by the addition of an operation such as rotation to the calibration apparatus 100 during the two transport operations. In order not to erroneously detect such a disturbance of the detection value, the presence or absence of the transport operation may be determined based on the moving average.

In the example of FIG. 8, the total value (here, moving average) of the detection value of the first acceleration sensor 180X and the detection value of the second acceleration sensor 180Y exceeds a first positive threshold value TH1 and then falls below a negative second threshold value TH2 within a predetermined time TS. Therefore, the arithmetic unit 171 determines that the transport operation is performed. In addition, thereafter, since the total value falls below the negative threshold value TH2 and then exceeds the positive threshold value TH1 within the predetermined time, the arithmetic unit 171 determines that the second transport operation is performed.

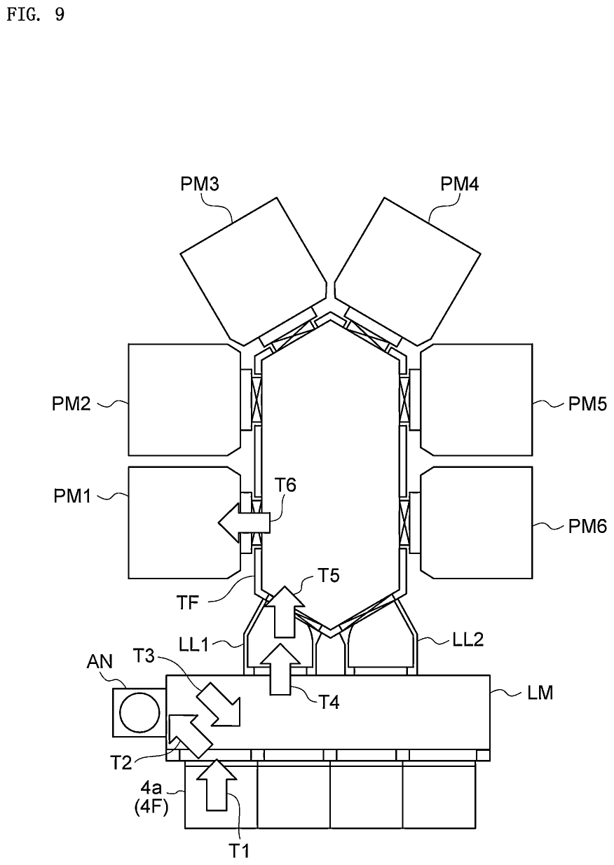

FIG. 9 is a view illustrating an example of a transport path of the calibration apparatus transported into the processing system. In a case where the calibration apparatus 100 is transported in the exemplary processing system 1, the calibration apparatus 100 is transported to a target position by a plurality of transport operations. For example, a case where the calibration apparatus 100 is transported to the process module PM1 is considered. The calibration apparatus 100 is transported by a step including the transport operations T1 to T6. The transport operation T1 is an operation for taking out from the container 4a (dedicated FOUP 4F). The transport operation T2 is an operation for transporting from the take-out position from the container 4a to the aligner AN. The transport operation T3 is an operation for taking out from the aligner AN. The transport operation T4 is an operation for transporting from the taking-out position from the aligner AN to the load-lock module LL1. The transport operation T5 is an operation for transporting from the load-lock module LL1 to the transfer module TF. The transport operation T6 is an operation for transporting from the transfer module TF to the process module PM1. In these transport operations T1 to T6, the states of acceleration applied to the calibration apparatus 100 may be different from each other. Therefore, in the exemplary calibration apparatus 100, the determination of the transport operation is performed based on the transport recipe.

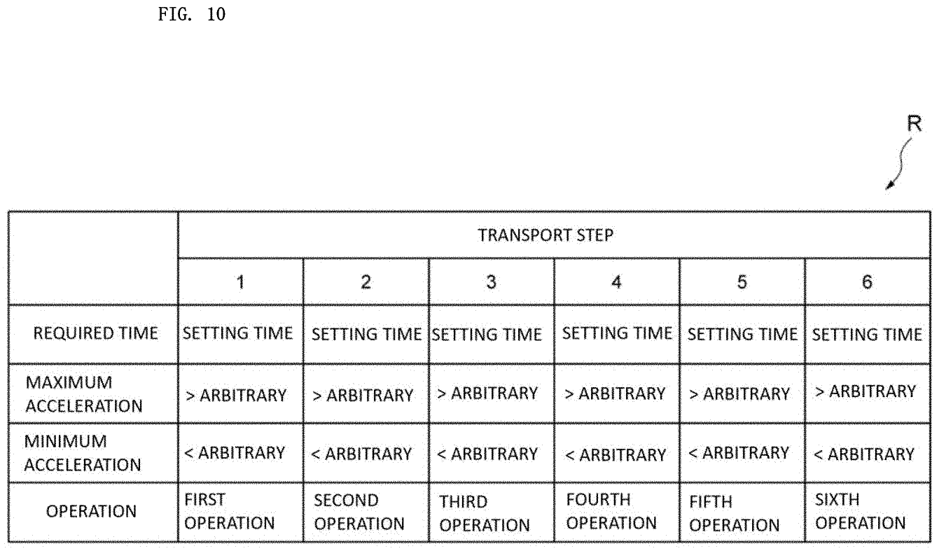

FIG. 10 is an example of a transport recipe used by the exemplary calibration apparatus. A transport recipe R may indicate a relationship between information on the acceleration applied to the calibration apparatus 100 transported into the transport device and information on the transport position. In the transport recipe R illustrated in FIG. 10, a required time, a maximum acceleration, a minimum acceleration, and an operation are associated with each transport operation performed sequentially. The maximum acceleration corresponds to the positive threshold value TH1 with respect to the total value (here, moving average) of the detection value by the first acceleration sensor 180X and the detection value by the second acceleration sensor 180Y. The minimum acceleration corresponds to the negative threshold value TH2 with respect to the total value. The required time is the time that elapses from the detection of the maximum value of the total value to the detection of the minimum value, or the time that elapses from the detection of the minimum value of the total value to the detection of the maximum value. That is, the required time corresponds to the time required from the start to the end of the transport, and corresponds to the predetermined time TS. The required time, the maximum acceleration, and the minimum acceleration may be arbitrarily determined for each operation.

In the example of FIG. 10, the first operation to the sixth operation corresponds to the transport operation T1 to the transport operation T6, respectively. Therefore, for example, at a point of time when it is determined by the arithmetic unit 171 that the second operation is performed, it can be recognized that the calibration apparatus 100 is located in the aligner AN. In addition, in a case where it is determined that the first operation to the sixth operation are ended, it can be recognized that the calibration apparatus 100 is placed in the process module PM1. When it is recognized that the calibration apparatus 100 is placed in the process module PM1, the arithmetic unit 171 causes the light emitting device 130 to emit light.

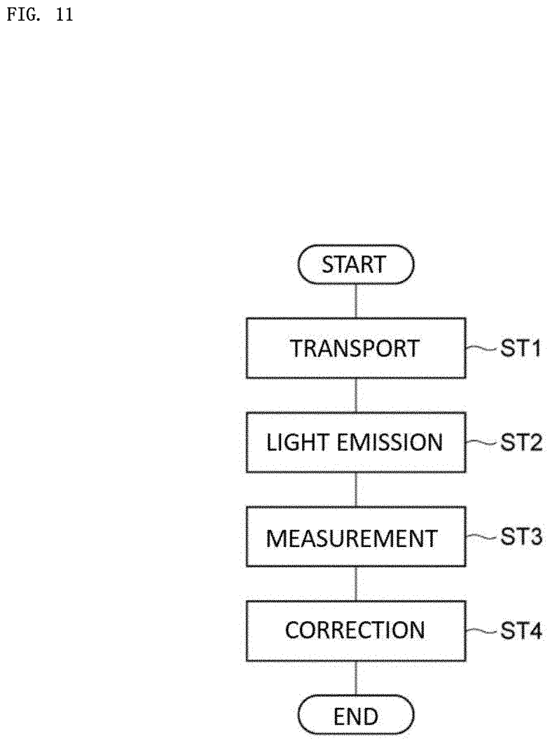

Subsequently, the operation of the calibration apparatus 100 will be described. FIG. 11 is a flowchart illustrating an example of an operation method of the calibration apparatus. As illustrated in FIG. 11, in an example of the operation method, the calibration apparatus 100 is transported into the process module PM by the transport device (Step ST1). In a case where the calibration apparatus 100 is operated, first, the calibration apparatus 100 placed in the dedicated FOUP 4F is activated. As described above, since the dedicated FOUP 4F is provided with the switch SW for activating the calibration apparatus 100, the calibration apparatus 100 can be activated by the switch SW. When the calibration apparatus 100 is activated, the acceleration sensor 180 operates, and a signal from the acceleration sensor 180 is acquired by the arithmetic unit 171. In a case where the calibration of the emission spectroscopy analyzer 72 is performed using the calibration apparatus 100, the calibration apparatus 100 is activated by the switch SW. At this time, the controller MC controls the processing system 1 so that the transport devices TU1 and TU2 transport the calibration apparatus 100 from the FOUP 4F to the stage ST in the process module PM. In addition, the controller MC controls the emission spectroscopy analyzer 72 to operate in the maintenance mode.

The arithmetic unit 171 derives a total value of acceleration based on the detection values acquired from the acceleration sensor 180. The arithmetic unit 171 recognizes the transport position of the calibration apparatus 100 by analyzing the derived total value with reference to the transport recipe R. The recognition of the transport position is the same as the determination of how far the operation of the transport recipe R is ended.

When it is recognized that the calibration apparatus 100 is transported into the process module PM1, the arithmetic unit 171 controls the controller 173 to cause the light source 131 to emit light (Step ST2). That is, when it is determined that the calibration apparatus 100 is placed on the electrostatic chuck ESC of the stage ST, the arithmetic unit 171 causes the predetermined light emitting device 130 to emit light. In a case where the emission spectroscopy analyzer 72 is on standby in the maintenance mode by the controller MC, the calibration of the emission spectroscopy analyzer 72 can be executed with the light source 131 being emitted as a trigger. That is, the emission spectroscopy analyzer 72 measures intensity data of the light from the light source 131 incident from the window 12w (Step ST3). The emission spectroscopy analyzer 72 compares the measured intensity data with reference intensity data held in advance, and corrects the measured intensity data so that the intensity data coincide with each other (Step ST4). In a case where the predetermined time elapses after the light source 131 emits light, the arithmetic unit 171 may determine that the calibration of the emission spectroscopy analyzer 72 is ended, and stop the light emission from the light source 131.

The calibration apparatus 100 may be transported a plurality of times between the process module PM and the aligner AN according to the calibration program of the emission spectroscopy analyzer 72. The arithmetic unit 171 may cause the light emitting device 130 to emit light each time it is determined that the calibration apparatus 100 is transported into the process module PM1. In this case, the transport recipe may include recipes corresponding to a plurality of transport operations between the process module PM and the aligner AN, in addition to the operation recipes when transporting from the FOUP 4F to the process module PM. Furthermore, the transport recipe may include a procedure of controlling the light emission from the light emitting device 130, in addition to the recipe of the transport operation. In this case, the arithmetic unit 171 can control the light emitting device 130 with reference to the transport recipe.

For example, the procedure of controlling the light emission included in the transport recipe is a procedure indicating that the different light emitting device 130 emits light for each transport operation between the process module PM and the aligner AN. In an example control procedure, a rotational position of the calibration apparatus 100 is adjusted in the aligner AN so that the light emitting device 130A is closest to the window 12w when transported into the process module PM. Thereafter, the light emitting device 130A emits light when it is recognized that the calibration apparatus 100 is transported into the process module PM, and the light emission is stopped after a predetermined time elapse.

Next, when the calibration apparatus 100 transported again to the aligner AN is transported into the process module PM, the rotational position of the calibration apparatus 100 is adjusted in the aligner AN so that the light emitting device 130B is closest to the window 12w. Thereafter, the light emitting device 130B emits light when it is recognized that the calibration apparatus 100 is transported into the process module PM, and the light emission is stopped after a predetermined time elapse.

Next, when the calibration apparatus 100 transported again to the aligner AN is transported into the process module PM, the rotational position of the calibration apparatus 100 is adjusted in the aligner AN so that the light emitting device 130C is closest to the window 12w. Thereafter, the light emitting device 130C emits light when it is recognized that the calibration apparatus 100 is transported into the process module PM, and the light emission is stopped after a predetermined time elapse.

Finally, when the calibration apparatus 100 transported again to the aligner AN is transported into the process module PM, the rotational position of the calibration apparatus 100 is adjusted in the aligner AN so that the light emitting device 130D is closest to the window 12w. Thereafter, the light emitting device 130D emits light when it is recognized that the calibration apparatus 100 is transported into the process module PM, and the light emission is stopped after a predetermined time elapse.

When the light emitting operations of all the light emitting devices 130A to 130D are ended, the emission spectroscopy analyzer 72 performs calibration of the spectrometer based on the intensity data of light of each wavelength obtained based on the light emission from the light emitting devices 130A to 130D. In addition, when the light emitting operations of all the light emitting devices 130A to 130D are ended, the calibration apparatus 100 is transported into the FOUP 4F by the transport devices TU1 and TU2. It is determined whether or not the calibration of the other emission spectroscopy analyzer 72 connected to the remaining process modules PM is ended. In a case where there is the emission spectroscopy analyzer 72 for which the calibration is not ended, the calibration apparatus 100 is transported to the process module PM connected to the emission spectroscopy analyzer 72, and the calibration of the emission spectroscopy analyzer 72 is performed through the same procedure as described above.

As described above, in the calibration apparatus 100, the arithmetic unit 171 controls the light source 131 so that the light is emitted from the light source 131 in a state where the calibration apparatus 100 is disposed on the stage ST provided in the process module PM. The light emitted from the light source 131 is reflected toward the outside of the base substrate 110 in a plan view by the reflection member 135. In the process module PM, in a case where the window 12w through which light is incident on the emission spectroscopy analyzer 72 is provided on the side of the stage ST, the light from the light source 131 reflected by the reflection member 35 is likely to be incident on the emission spectroscopy analyzer 72. That is, the intensity of light incident on the emission spectroscopy analyzer 72 increases. Since the light from the light source 131 can be used as a reference for calibration, the emission spectroscopy analyzer 72 can be calibrated by the calibration apparatus 100. In addition, the calibration apparatus 100 is driven by an installed battery 140. Since the reflection member 135 can efficiently irradiate the window 12w with the light from the light source 131, the consumption of the battery 140 is suppressed, and the light source 131 can be operated for a long time. As a result, it is possible to perform the calibration of a plurality of emission spectroscopy analyzers 72 connected to the plurality of process modules PM.

In one exemplary embodiment, each of the plurality of light sources 131 is an LED light source. With this configuration, it is possible to suppress the generation of heat from the light source and suppress the power consumption by the light source.

In one exemplary embodiment, the base substrate 110 has a disk shape and includes a notch at a part of a peripheral edge thereof. With this configuration, since the rotational position of the calibration apparatus 100 can be controlled by the aligner AN, the calibration apparatus 100 can be transported to the process module PM at an appropriate rotational position by the aligner AN and the transport devices TU1 and TU2.

In one exemplary embodiment, the plurality of light emitting devices 130 are arranged in the circumferential direction along the peripheral edge of the base substrate 110. With this configuration, any one of the plurality of light emitting devices 130 can be brought close to the window 12w in the process module PM.

In the process module PM, the calibration apparatus 100 cannot be controlled wirelessly. However, in a case where the emission spectroscopy analyzer 72 is calibrated using the light emitting device 130, it is not necessarily preferable to cause the light emitting device 130 to emit light even during the transport operation. Therefore, in one exemplary embodiment, the acceleration sensor 180 disposed in the base substrate 110 is further provided. The arithmetic unit 171 may recognize the transport position of the calibration apparatus 100 based on the output value of the acceleration sensor 180, and may cause the light source 131 to emit light when it is recognized that the calibration apparatus 100 is transported into the process module PM.

While various exemplary embodiments have been described above, various omissions, substitutions, and changes may be made without being limited to the exemplary embodiments described above.

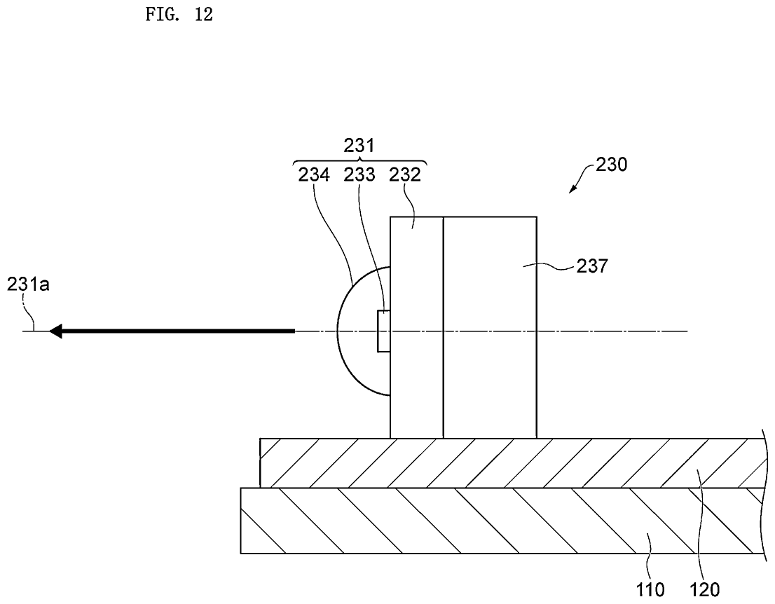

For example, an example in which the light emitted from the light emitting device 130 is reflected by the reflection member is described, the light emitting device may not include the reflection member. FIG. 12 is a cross-sectional view of a calibration apparatus illustrating a light emitting device 230 according to another example. Similar to the light emitting device 130, the light emitting device 230 illustrated in FIG. 12 is one of a plurality of light emitting devices that emit light having different wavelengths from each other and are disposed apart from each other on the peripheral edge of the control substrate 120. The light emitting device 230 is disposed on the control substrate 120. The light emitting device 230 includes a light source 231. Similar to the light emitting device 130, the exemplary light source 231 includes a substrate 232, an LED element 233 provided on the substrate 232, and a lens 234 that covers the LED element 233.

The orientation of the optical axis 231a of the exemplary light source 231 is directed toward the outside of the base substrate 110 in a plan view. That is, the light irradiated from the light source 231 travels toward the outside of the base substrate 110 in a plan view. In other words, the light source 231 irradiates toward the outside of the base substrate 110 with light. In the illustrated example, the optical axis 231a of the light source 231 extends along the radial direction of the base substrate 110 and is parallel to the upper surface of the base substrate 110 in a plan view. The angle of the optical axis 231a of the light source 231 may be adjusted to be directed toward the window 12w. For example, the optical axis 231a of the light source 231 may be inclined at a predetermined angle with respect to a plane parallel to the base substrate 110. For example, the light source 231 may irradiate obliquely upward toward the outside of the base substrate 110 with light.

In the light emitting device 230, the optical axis of the light source 231 is directed toward the outside of the base substrate 110 in a plan view, similar to the light emitting device 130. With this configuration, in the process module PM, in a case where the window 12w through which light is incident on the emission spectroscopy analyzer 72 is provided on the side of the stage ST, the light from the light source 231 is likely to be incident on the emission spectroscopy analyzer 72.

In addition, as the reflection member 135, a reflecting plate having a planar reflecting surface 135a is exemplified, but other forms of the reflection member may be used. For example, the reflection member may have a nonplanar reflecting surface such as a projected surface or a recessed surface. In addition, the reflection member may be, for example, an optical component having a reflecting surface such as a prism.

In addition, an example in which the light emitting devices 130 are disposed at four positions around the peripheral edge on the base substrate is described, the number of the light emitting devices is not particularly limited. The number of light emitting devices may be three or less, or may be five or more. For example, ten types of light emitting devices that output light having different wavelengths from each other may be respectively disposed at ten positions spaced apart in the circumferential direction on the peripheral edge of the base substrate.

From the foregoing description, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A calibration apparatus for calibrating an emission spectroscopy analyzer that monitors plasma generated in a plasma processing apparatus, the calibration apparatus comprising:
a base substrate;
a plurality of light emitting devices disposed on the base substrate, each light emitting device of the plurality of light emitting devices is configured to emit light having different wavelengths from other light emitting devices of the plurality of light emitting devices;
a reflector disposed on the base substrate, the reflector configured to reflect the light emitted by the plurality of light emitting devices toward an outside of the base substrate in a plan view; and
a control device disposed on the base substrate, the control device configured to control the plurality of light emitting devices.

2. The calibration apparatus according to claim 1, wherein
each light emitting device of the plurality of light emitting devices is an LED light source.

3. The calibration apparatus according to claim 1, wherein
the base substrate has a disk shape and includes a notch at a peripheral edge of the base substrate.

4. The calibration apparatus according to claim 2, wherein
the base substrate has a disk shape and includes a notch art a peripheral edge of the base substrate.

5. The calibration apparatus according to claim 1, wherein
the plurality of light emitting devices are arranged in a circumferential direction along a peripheral edge of the base substrate.

6. The calibration apparatus according to claim 2, wherein
the plurality of light emitting devices are arranged in a circumferential direction along a peripheral edge of the base substrate.

7. The calibration apparatus according to claim 3, wherein
the plurality of light emitting devices are arranged in a circumferential direction along a peripheral edge of the base substrate.

8. The calibration apparatus according to claim 1, further comprising:
an acceleration sensor disposed on the base substrate, wherein
the control device is further configured to
recognize a transport position of the calibration apparatus in the plasma processing apparatus based on an output value of the acceleration sensor, and
control the plurality of light emitting devices to emit light in a case that the recognized transport position indicates that that the calibration apparatus is transported to a predetermined position.

9. A calibration apparatus for calibrating an emission spectroscopy analyzer that monitors plasma generated in a plasma processing apparatus, the calibration apparatus comprising:
a base substrate;
a plurality of light emitting devices disposed on the base substrate, each light emitting device of the plurality of light emitting devices is configured to emit light having different wavelengths from other light emitting devices of the plurality of light emitting devices; and a control device disposed on the base substrate, the control devices configured to control the plurality of light emitting devices, wherein
an optical axis of the plurality of light emitting devices is directed toward an outside of the base substrate in a plan view.

10. The calibration apparatus according to claim 9, wherein
each light emitting device of the plurality of light emitting devices is an LED light source.

11. The calibration apparatus according to claim 9, wherein
the base substrate has a disk shape and includes a notch at a peripheral edge of the base substrate.

12. The calibration apparatus according to claim 10, wherein
the base substrate has a disk shape and includes a notch at a peripheral edge of the base substrate.

13. The calibration apparatus according to claim 9, wherein
the plurality of light emitting devices are arranged in a circumferential direction along a peripheral edge of the base substrate.

14. The calibration apparatus according to claim 10, wherein
the plurality of light emitting devices are arranged in a circumferential direction along a peripheral edge of the base substrate.

15. The calibration apparatus according to claim 11, wherein
the plurality of light emitting devices are arranged in a circumferential direction along a peripheral edge of the base substrate.

16. The calibration apparatus according to claim 9, further comprising:
an acceleration sensor disposed on the base substrate, wherein
the control device is further configured to
recognize a transport position of the calibration apparatus in the plasma processing apparatus based on an output value of the acceleration sensor, and
control the plurality of light emitting devices to emit light in a case that the recognized transport position indicates that that the calibration apparatus is transported to a predetermined position.

17. A calibration method of calibrating an emission spectroscopy analyzer that monitors plasma generated in a plasma processing apparatus using a calibration apparatus, the calibration method comprising:
transporting the calibration apparatus into the plasma processing apparatus by a transport device;
controlling, by a controller of the calibration apparatus, a plurality of light emitting devices disposed on a base substrate of the calibration apparatus to emit light, each light emitting device of the plurality of light emitting devices emitting light having different wavelengths from other light emitting devices of the plurality of light emitting devices, and the light emitted by the plurality of light emitting devices being reflected by a reflector disposed on the base substrate toward an outside of the base substrate in a plan view;
measuring intensity data of the light emitted from the plurality of light emitting devices by the emission spectroscopy analyzer; and
calibrating the emission spectroscopy analyzer based on the intensity data.

18. The calibration method according to claim 17, wherein
each light emitting device of the plurality of light emitting devices is an LED light source.

19. The calibration method according to claim 17, wherein
the base substrate has a disk shape and includes a notch at a peripheral edge of the base substrate.

20. The calibration method according to claim 17, further comprising:
recognizing a transport position of the calibration apparatus in the plasma processing apparatus based on an output value of an acceleration sensor; and
controlling the plurality of light emitting devices to emit light in a case that the recognized transport position indicates that that the calibration apparatus is transported to a predetermined position.
